(19) United States
(12) Patent Application Publication
(10) Pub. No.: US 2005/0037659 A1
(43) Pub. Date: Feb. 17, 2005

(54) Memory card connector

(76) Inventor: Lee-Jen Wu, Taipei (TW)

Correspondence Address: MOLEX INCORPORATED, 2222 WELLINGTON COURT, LISLE, IL, 60532, US

(21) Appl. No.: 10/916,033

(22) Filed: Aug. 11, 2004

(30) Foreign Application Priority Data
Aug. 15, 2003 (TW) 92214838

(51) Int. Cl. H01R 13/62

(52) U.S. Cl. 439/374

(57) ABSTRACT

A memory card connector includes an insulating housing which at least in part defines a card-receiving space for receiving one or more different types of memory cards. First and second sets of conductive terminals are mounted on the housing for engaging appropriate contacts of first and second different types of memory cards inserted into the space. First and second conductive guide terminals are respectively mounted at opposite sides of the card-receiving space. The guide terminals include generally rigid body portions having first guide surfaces for guiding the first type of memory card into the card-receiving space and second guide surfaces independent of the first guide surfaces for guiding the second type of memory card into the card-receiving space.

### FIELD OF THE INVENTION

This invention generally relates to the art of electrical connectors and, particularly, to a memory card connector.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like.

Some memory card connectors are provided with a write-protection function by means of a pair of elastic conductive terminals forming a controlling switch. The two switch terminals are mounted at a side of the connector and have respective elastic arms arranged in close proximity to each other and may be moved into mutual engagement by the memory card to close the controlling switch. Some memory card connectors also are provided with a card detector function by means of a third switch terminal which may be moved into engagement with one of the other switch terminals by a memory card, such as by a leading edge of the card. This indicates or detects that the card is fully inserted into the connector.

FIG. 1 shows a conventional memory card connector, generally designated 10, of the character described. The connector includes an insulative housing, generally designated 12, which mounts a plurality of terminals, generally designated 14. The housing has a rear base 16, along with a pair of side wall sections 18 to define a generally U-shaped configuration. Typically, a metal shell (not shown) is mounted on top of the housing and combines therewith to define an interior cavity 20 for receiving a memory card inserted into the cavity in the direction of arrow “A” between side wall sections 18 of the housing and above base sections 16. Appropriate contacts on the memory card engage cantilevered contact portions 14a of connector terminals 14. The contact portions extend forwardly into the cavity. The connector is adapted for mounting on a printed circuit board, and the connector terminals include tail portions 14b for connection, as by soldering, to appropriate circuit traces on the board.

Prior art connector 10 includes a write-protection function and a first switch terminal, generally designated 22, is mounted in a first slot 24 in one of the side wall sections 18 of the housing. The first switch terminal includes a contact arm 22a. The connector includes a card detector function, and a second switch terminal, generally designated 26, is mounted in a second slot 28 in a rear section 29 of the housing. A third switch terminal, generally designated 30, is L-shaped and is mounted in an L-shaped slot 32 which extends into both a rear section 33 and the one side wall section of the housing. Second switch terminal 26 includes a resilient contact arm 26a which is angled forwardly into cavity 20 in front of a resilient contact arm 30a of third switch terminal 30.

When a memory card is inserted into cavity 20 of prior art connector 10, a side edge of the memory card engages a resilient contact arm 30b of the third switch terminal 30 and biases the arm into engagement with contact arm 22a of first switch terminal 22. This closes the “switch” defined by the first and third switch terminals to effect the write-protection function.

When the memory card is inserted fully into cavity 20, a leading edge of the memory card engages resilient contact arm 26a of second switch terminal 26 and biases the contact arm into engagement with resilient contact arm 30a of third switch terminal 30. This automatically closes the “switch” defined by the second and third switch terminals to effect the card detector function of the connector.

The prior art memory card connector of FIG. 1 has a disadvantage of providing a connecting function for only a single specific type of memory card, which limits the use of the connector. Therefore, a specifically configured connector must be designed individually for each type of memory card, which greatly increases manufacturing and inventory costs, as well as creating puzzlement for the manufacturers.

Although there exists some memory card connectors which can accommodate different sizes or types of memory cards, the card receiving space(s) of the connector is considerably enlarged for receiving memory cards of different widths and thicknesses. The connectors have problems in properly fitting and holding the different sizes of cards. The alignment means for the cards are quite complex and are required to be molded into the connector housing for both guiding and retaining the different memory cards. The present invention is directed to solving these problems and curing the disadvantages of prior art memory cards.

### SUMMARY OF THE INVENTION

An object, therefore, of the invention is to provide a new and improved memory card connector of the character described.

In the exemplary embodiment of the invention, the memory card connector includes an insulating housing which at least in part defines a card-receiving space for receiving one or more different types of memory cards. First and second sets of conductive terminals are mounted on the housing for engaging appropriate contacts of first and second different types of memory cards inserted into the space. First and second conductive guide terminals are respectively mounted at opposite sides of the card-receiving space. The guide terminals include generally rigid body portions having first guide surfaces for guiding the first type of memory card into the card-receiving space and second guide surfaces independent of the first guide surfaces for guiding the second type of memory card into the card-receiving space.

According to one aspect of the invention, the body portions of the guide terminals have inverted L-shaped configurations to define upright walls and horizontal walls projecting inwardly toward the card-receiving space. Inside surfaces of the upright walls define the first guide surfaces for guiding the first type of memory card into the card-receiving space. Inside edges of the horizontal walls define the second guide surfaces for guiding the second type of memory card into the space.

According to another aspect of the invention, a third set of conductive terminals are mounted on the housing for engaging appropriate contacts on a third type of memory card. The tops of the horizontal walls of the guide terminals define third guide surfaces independent of the first and second guide surfaces for guiding the third type of memory card into the card-receiving space.

According to a further aspect of the invention, one of the first or second conductive guide terminals comprises a fixed write-protection switch terminal. A movable write-protection switch terminal has a portion engageable by a memory card inserted into the card-receiving space to move the movable switch terminal into engagement with the fixed switch terminal to close the “switch” defined thereby and effect the write-protection function of the connector.

According to still another aspect of the invention, one of the first or second conductive guide terminals comprises a fixed card detection switch terminal. A movable card-detection switch terminal has a portion engageable by a memory card inserted into the card-receiving space to move the movable switch terminal into engagement with the fixed switch terminal to close the “switch” defined thereby and effect the card detection function of the connector.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is top plan view of the prior art memory card connector described in the Background, above;

FIG. 2 is a top, front perspective view of a memory card connector according to a first embodiment of the invention;

FIG. 3 is a bottom, front perspective view of the memory card of FIG. 2;

FIG. 4 is a front perspective view of the first embodiment, with the two guide terminals removed from the connector housing;

FIG. 5 is a front elevational view of the first embodiment;

FIG. 6 is a rear elevational view of the first embodiment;

FIG. 7 is a perspective view of the two guide terminals along with the movable write-protection terminal and the card detection terminal;

FIG. 8 is a perspective view of the first embodiment receiving an SD type memory card;

FIG. 8A is a perspective view of the SD memory card;

FIG. 9 is a front elevational view of the first embodiment receiving the SD memory card;

FIG. 10 is a bottom perspective view of the first embodiment receiving an MS type memory card;

FIG. 11 is a front elevational view of FIG. 10;

FIG. 12 is a bottom perspective view of the first embodiment receiving an SM type memory card;

FIG. 13 is a front elevational view of FIG. 12;

FIG. 14 is a top, front perspective view of a memory card connector according to a second embodiment of the invention;

FIG. 14A is a perspective view of the guide terminal assemblies of the second embodiment;

FIG. 15 is an exploded perspective view of the connector of the second embodiment;

FIG. 16 is a perspective view of an XD type memory card inserted into the connector f the second embodiment;

FIG. 16A is a bottom perspective view of the XD memory card;

FIG. 17 is a perspective view of a memory card connector according to a third embodiment of the invention, with the write-protection and card detection guide terminal assemblies removed from the connector;

FIG. 18 is a top plan view of the right-hand terminal assembly shown in FIG. 17; and

FIG. 19 is a perspective view of the write-protection and card detection guide switch terminal assemblies according to a fourth embodiment of the invention.

### DETAILED DESCRIPTION OF THE PREFERRED EMBODIMENTS

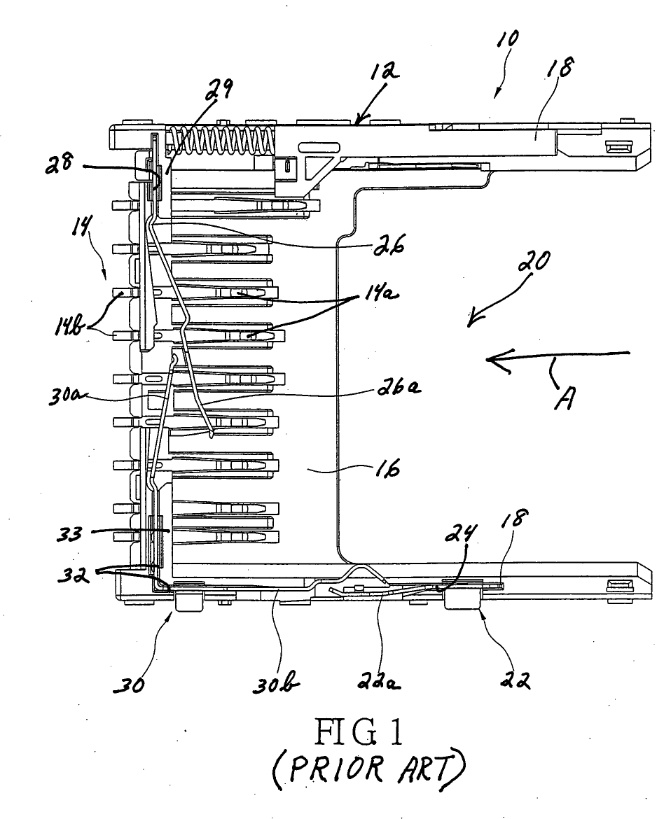

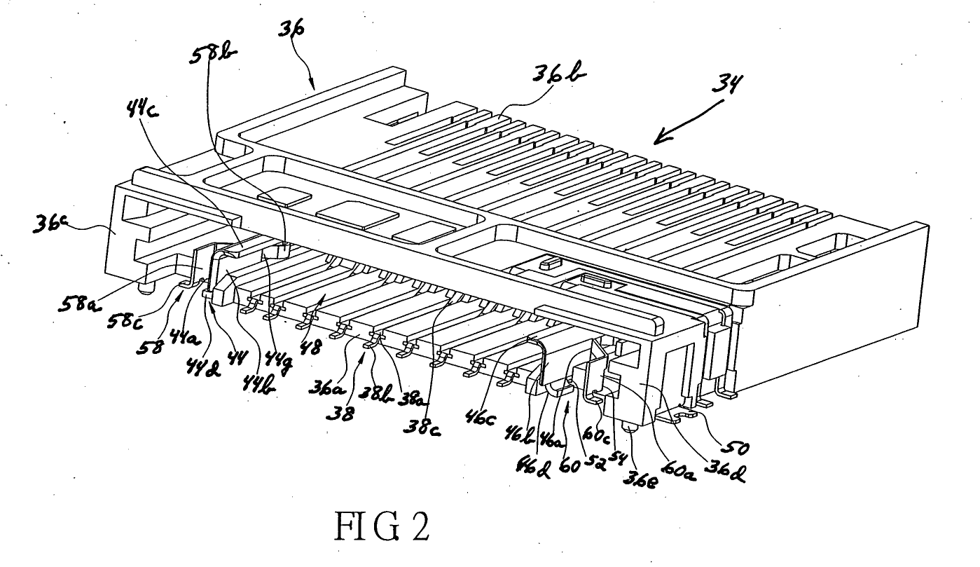

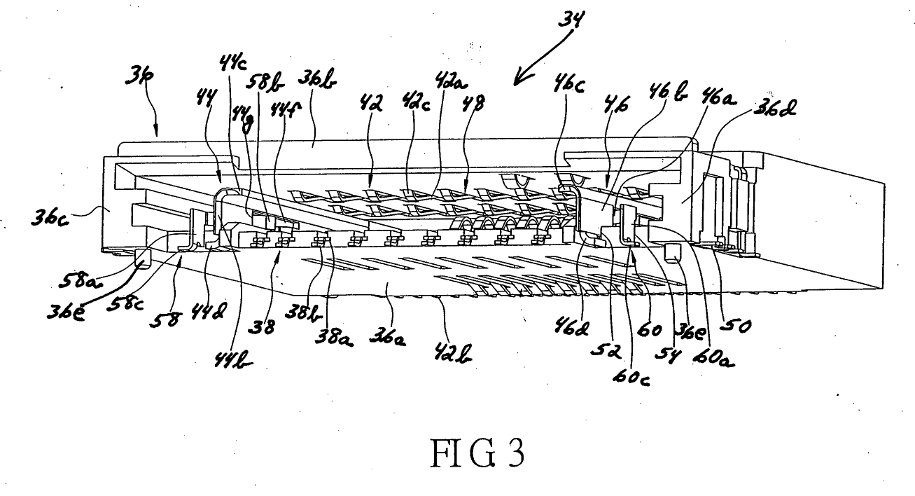

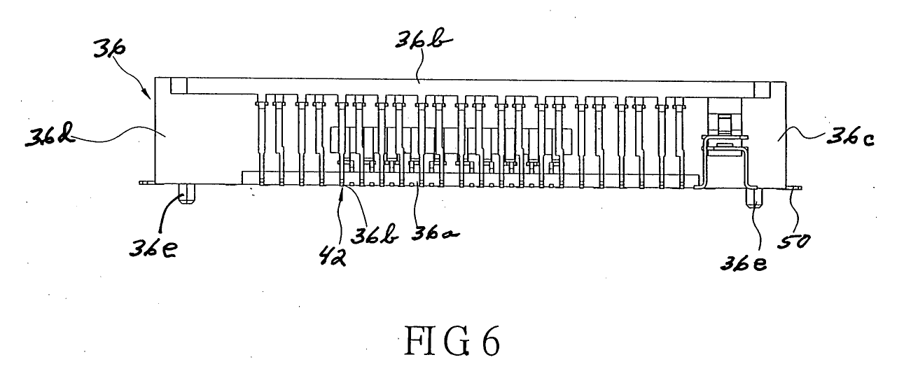

Referring to the drawings in greater detail, and first to FIGS. 1-6, a first embodiment of a memory card connector, generally designated 34, includes a dielectric or insulating housing, generally designated 36 which mounts a first set, generally designated 38, of conductive terminals; a second set, generally designated 40, of conductive terminals; a third set, generally designated 42, of conductive terminals; a first conductive guide terminal, generally designated 44; and a second conductive guide terminal, generally designated 46. All of these terminals may be stamped and formed of conductive sheet metal material. Housing 36 may be molded of dielectric material such as plastic or the like. As will be understood hereinafter, guide terminal 44 is a fixed write-protection terminal, and guide terminal 46 is a fixed card-detection terminal.

Housing 36 of connector 14 includes a base portion 36a, a top portion 36b attached to the base portion, and left and right side wall portions 36c and 36d, respectively. Therefore, a card-receiving space, generally designated 48, is defined and surrounded by the base portion, top portion and side wall portions of the housing. The card-receiving space is large enough and appropriately configured for receiving different types of memory cards (e.g., SD, MS, SM and XD cards) with different widths and thicknesses.

Housing 36 of connector 34 is adapted for mounting on a printed circuit board and includes at least a pair of mounting posts 36e for positioning in appropriate mounting holes in the board. A metal fixing member 50 is mounted at the outside of each side wall portion 36c and 36d of the housing for securing, as by soldering, to appropriate solder pads on the printed circuit board to firmly fasten the connector to the board.

Housing 36 of connector 34 further includes a pair of front-opening grooves 52 spaced laterally of base portion 36a, generally inside side wall portions 36c and 36d. These grooves extend rearwardly into the housing and have narrow slots (not shown) at the rear ends thereof. In addition, a pair of narrow slots 54 are formed in the front face of base portion 36a outside grooves 52.

The sets 38, 40 and 42 of conductive terminals each includes a plurality of terminals 38a, 40a and 42a, respectively. As stated above, the terminals are stamped and formed of conductive sheet metal material. The terminals are elongated and extend in the insertion/retraction direction of the memory card(s). The sets 38, 40 and 42 of the terminals are arranged in three sequential rows in the top and bottom portions 36b and 36a, respectively, of the housing.

Each terminal 38a of set 38 includes a solder tail portion 38b for soldering to an appropriate circuit trace on the printed circuit board, along with a contact portion 38c projecting into card-receiving space 48. Similarly, terminals 40a and 42a of sets 40 and 42, respectively, include solder tails 40b and 42b, respectively, along with contact portions 40c and 42c, respectively. The contact portions of the three sets of terminals extend into card-receiving space 48 at different locations for engaging the contacts of different types of memory cards.

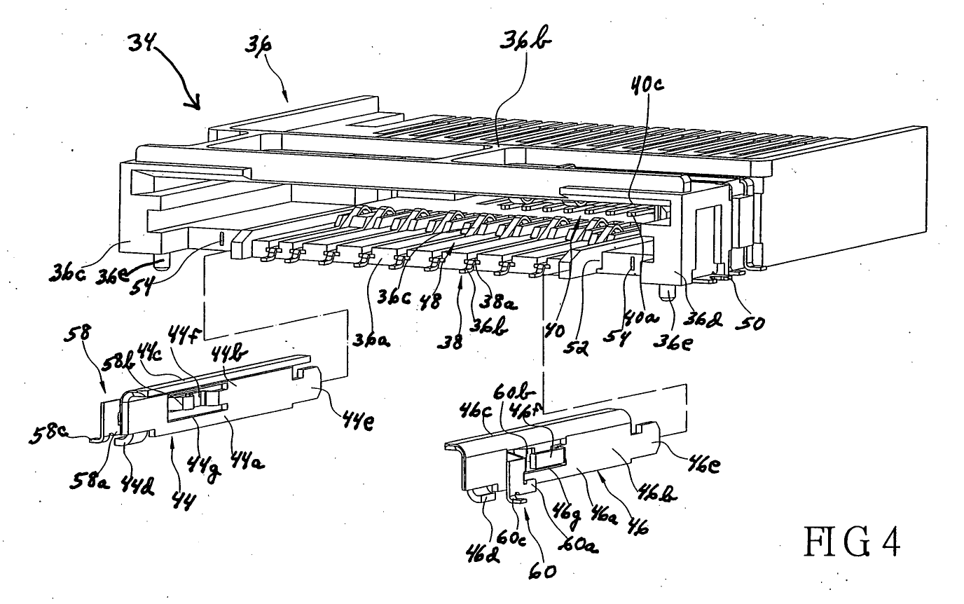

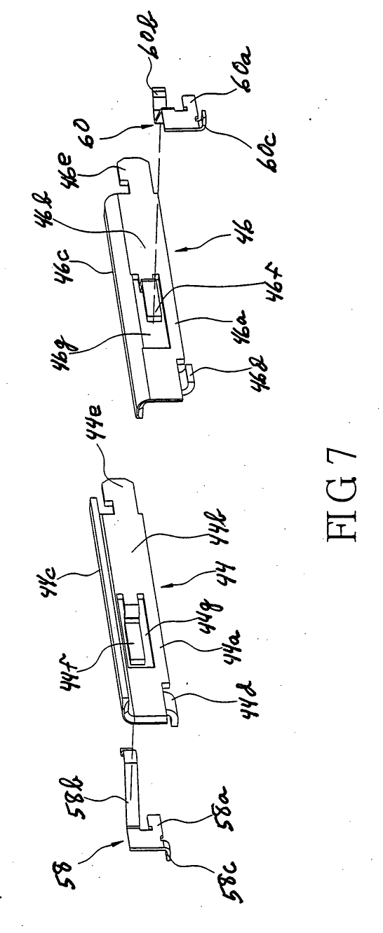

As best seen in FIGS. 4 and 7, guide terminal 44 includes a generally rigid body portion 44a which is generally L-shaped and includes an upright, generally planar wall 44b and an inwardly turned horizontal wall 44c. The terminal may be stamped and formed of conductive sheet metal material. The terminal includes a foot portion 44d for connection, as by soldering, to an appropriate circuit trace on the printed circuit board. The terminal is mounted in one of the grooves 52 of housing 36, and a fixing tongue 44e is formed as an extension of upright wall 44b for insertion into the narrow slot at the rear or inner end of groove 52 to rigidly fix the terminal to the housing. An elastic contact arm 44f is stamped and formed out of an opening 44g in upright wall 44b, with the contact arm bent outwardly of the plane of the upright wall.

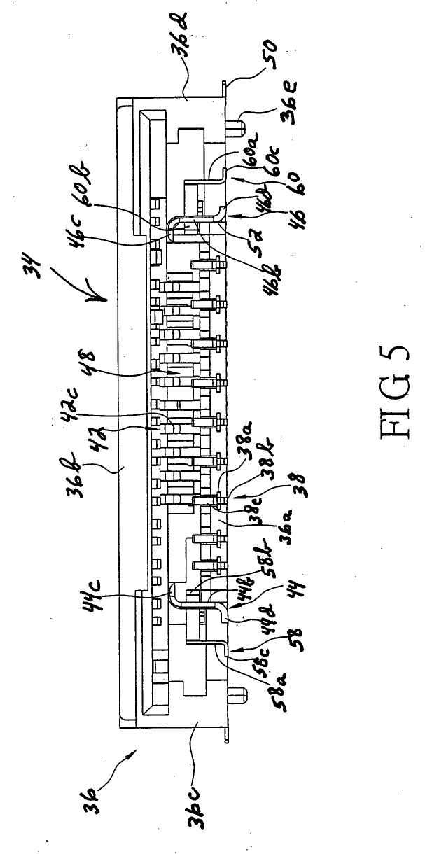

Guide terminal 44 is a fixed write-protection switch terminal in connector 34. Still referring to FIGS. 4 and 5, a movable write-protection switch terminal, generally designated 58, is mounted immediately outside terminal 42. The movable write-protection switch terminal includes a fixing tongue 58a which is press-fit into the left-hand narrow slot 54 in the front face of base portion 36a of the housing to fix the terminal to the housing. However, the terminal includes a flexible or movable contact arm 58b which extends through opening 44g in terminal 44 as best seen in FIG. 4. This locates movable contact arm 58b spaced from and inside elastic contact arm 44f of terminal 44. Contact arm 58b, in essence, projects into the card-receiving space 48 for engagement by a memory card. Finally, write-protection switch terminal 58 has a foot portion 58c for connection, as by soldering, to an appropriate circuit trace on the printed circuit board. As will be seen hereinafter, guide terminal 44 performs a dual function of guiding different types of memory cards into card-receiving space 48, as well as forming a fixed write-protection switch terminal for the connector.

Similarly, the right-hand guide terminal 46 performs a dual function of guiding different types of memory cards into the card-receiving space of the connector, and also forms a fixed card detection terminal for the connector. Specifically, guide terminal 46 is a mirror image of guide terminal 44 and includes a body portion 46a, a generally planar upright wall 46b, a horizontal inwardly turned wall 46c, a solder foot 46d, a fixing tongue 46e, and an elastic contact arm 46f formed out of an opening 46g in upright wall 46b. A movable card detection switch terminal 60 is a mirror image of write-protection switch terminal 58 and includes a fixing tongue 60a, a flexible or movable contact arms 60 and a solder foot 60c. Like guide terminal 44, guide terminal 46 is mounted in the right-hand groove 52 of housing 36, and fixing tongue 60a of card detection switch 60 is fixed within the right-hand narrow slot of the housing. Movable contact arm 60b of switch terminal 60 extends through opening 46g in guide terminal 46 so that the movable contact arm is spaced inwardly of elastic contact arm 46f, with the movable contact arm projecting into the card-receiving space for engagement by an inserted memory card.

Therefore, fixed terminal 44 and movable terminal 58 form a write-protection switch terminal assembly of the connector. Fixed terminal 46 and movable terminal 60 form a card detection switch terminal assembly of the connector.

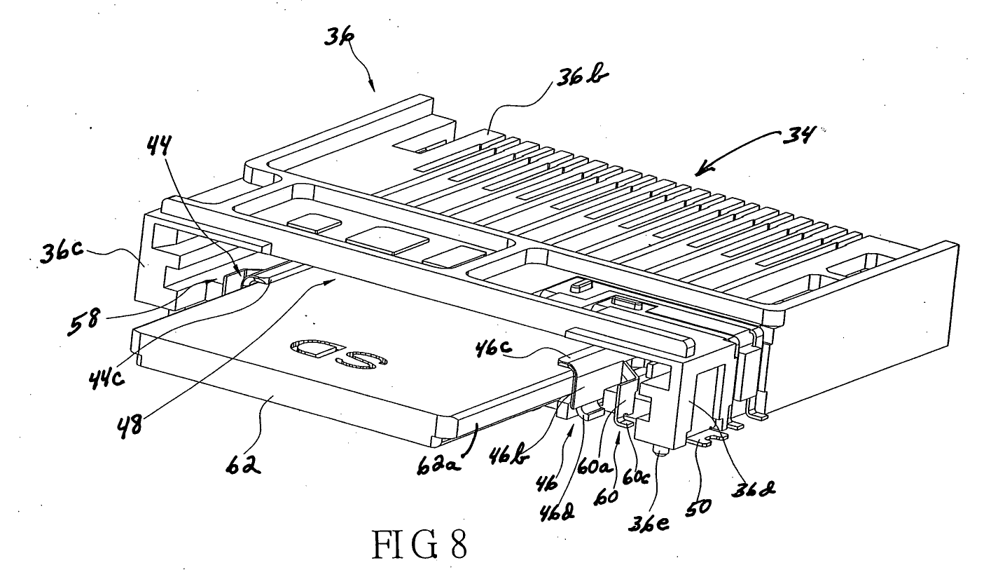

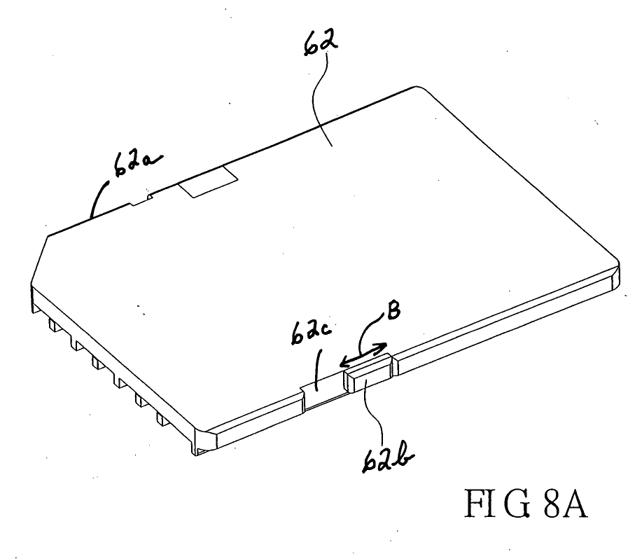

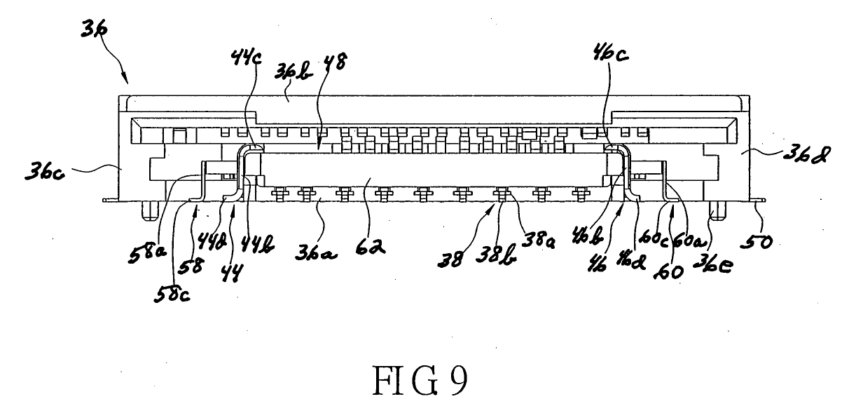

FIGS. 8, 8A and 9 show an SD type memory card 62 which is insertable into card-receiving space 48 as shown in FIGS. 8 and 9. When inserted, the inside surfaces of upright walls 44b and 46b of guide terminals 44 and 46, respectively, are engageable with the side edges of the card and act as guide surfaces for guiding the SD card into the card-receiving space. It can be seen in FIGS. 8 and 9 that the bottom surfaces of horizontal walls 44c and 46c of guide terminals 44 and 46, respectively, are engageable with the top of the card and also guide the SD card into the connector.

When the SD card 62 is inserted into the connector, one edge 62a thereof engages movable contact arm 60b (FIGS. 4 and 7) of card detection switch terminal 60 and biases the movable contact arm into engagement with elastic contact arm 46f of guide terminal 46. This closes the “switch” defined by terminals 46 and 60 to effect a card detection function of the connector. Appropriate contacts on card 62 engage contact portions 38c of terminals 38a of the first set 30 of terminals.

As seen in FIG. 8A, a control component 62b on memory card 62 is movable in the direction of double-headed arrow [symbol] B [symbol] within a recess 62c in the memory card. When the control component is in a write-protection mode, the control component will be aligned with movable contact arm 58b (FIGS. 4 and 7) of write-protection switch terminal 58. This will bias movable contact arm 58b into engagement with elastic contact arm 44f of guide terminal 44 to close the “switch” defined by terminals 44 and 58 to effect a write-protection function of the connector. If control component 62b is moved to the opposite end of recess 62c, the recess will be aligned with movable contact arm 58b of write-protection switch terminal 58, and the movable contact arm will not be biased into engagement with elastic contact arm 44f of guide terminal 44.

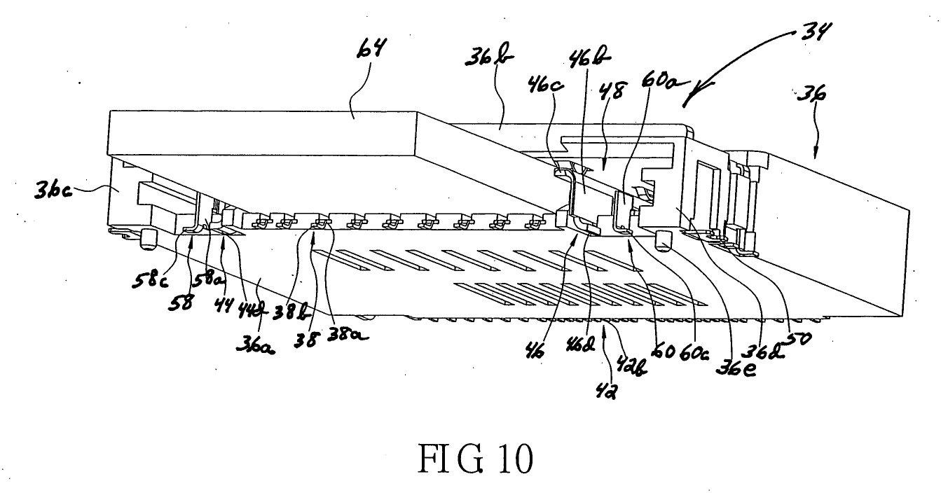

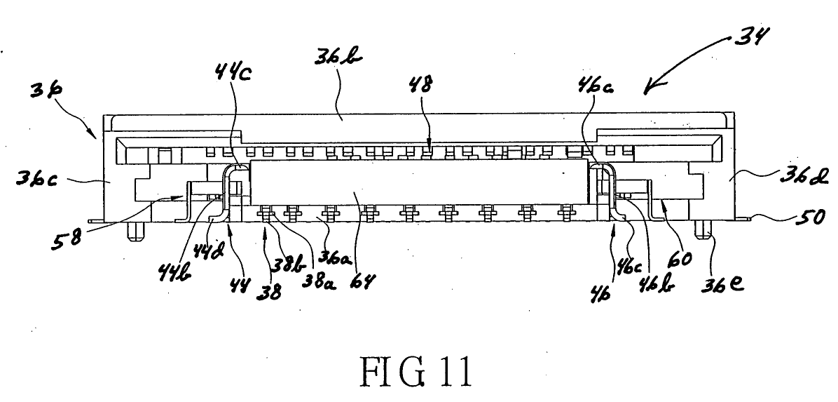

FIGS. 10 and 11 show an MS type memory card 64 inserted into card-receiving space 48 of connector 34. As best seen in FIG. 11, the inside edges of horizontal walls 44c and 46c of guide terminals 44 and 46, respectively, form guide surfaces for guiding the MS card into the card-receiving space. When fully inserted, appropriate contacts on memory card 64 engage contact portions 40c of terminals 40a of the second set of terminals 40. It can be seen that guide terminals 44 and 46 are used to guide both the SD card (FIGS. 8 and 9) as well as the MS card (FIGS. 10 and 11).

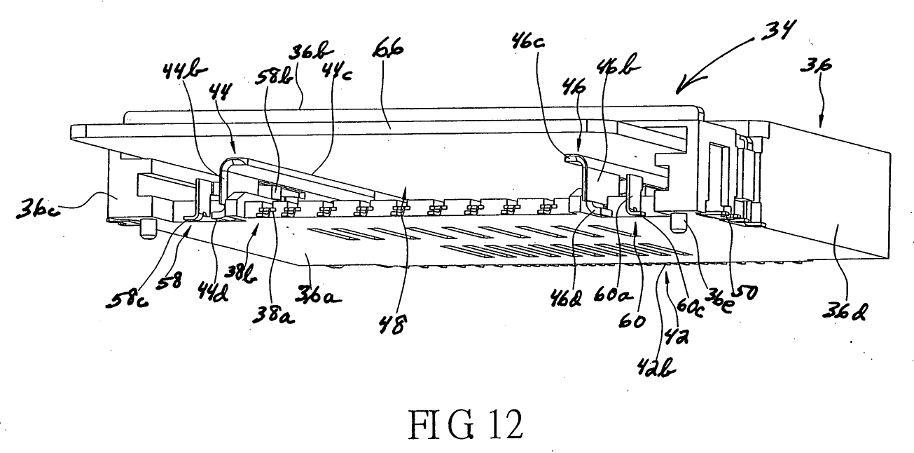

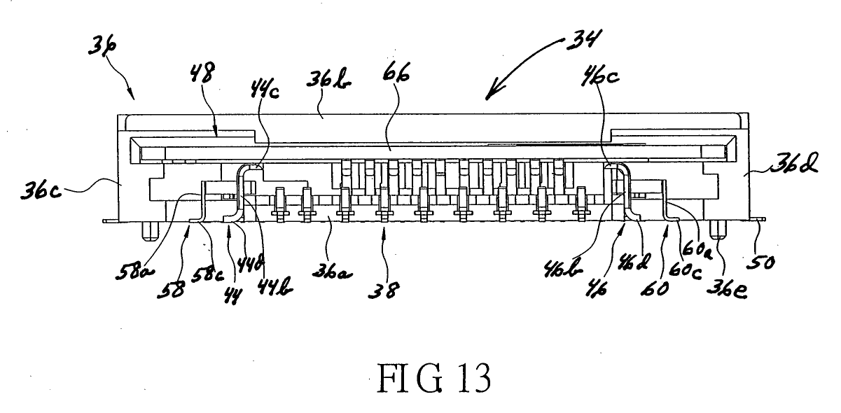

FIGS. 12 and 13 show an SM memory card 66 inserted into card-receiving space 48 of housing 36 of connector 34. When fully inserted, appropriate contacts on memory card 66 engage the contact portions of the terminals in the third set of terminals 42. As can be seen in FIGS. 12 and 13, the top surfaces of horizontal walls 44c and 46c of guide terminals 44 and 46, respectively, guide the SM memory card 66 into card-receiving space 48.

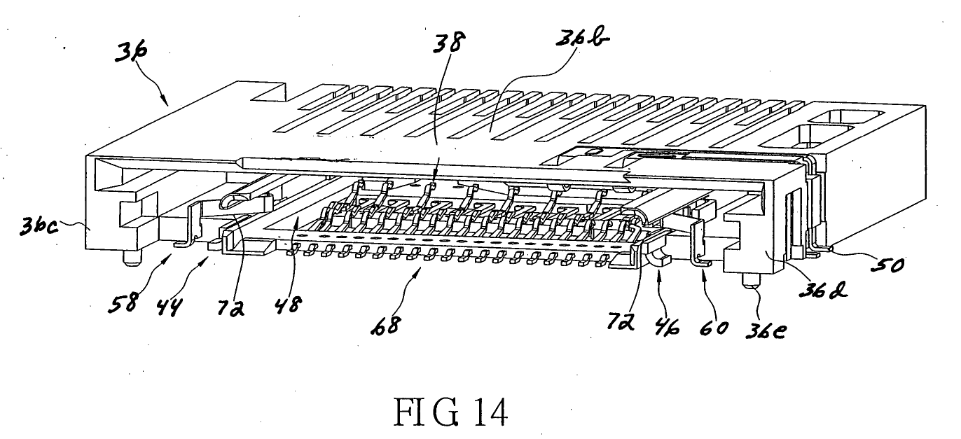

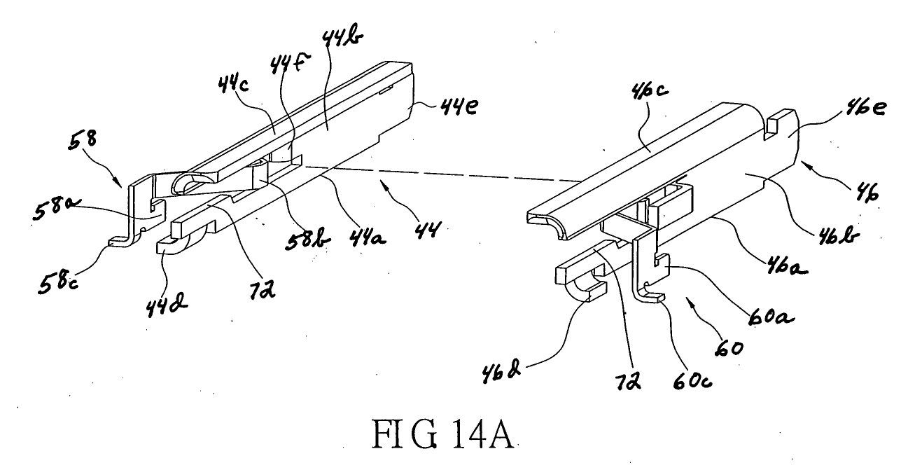

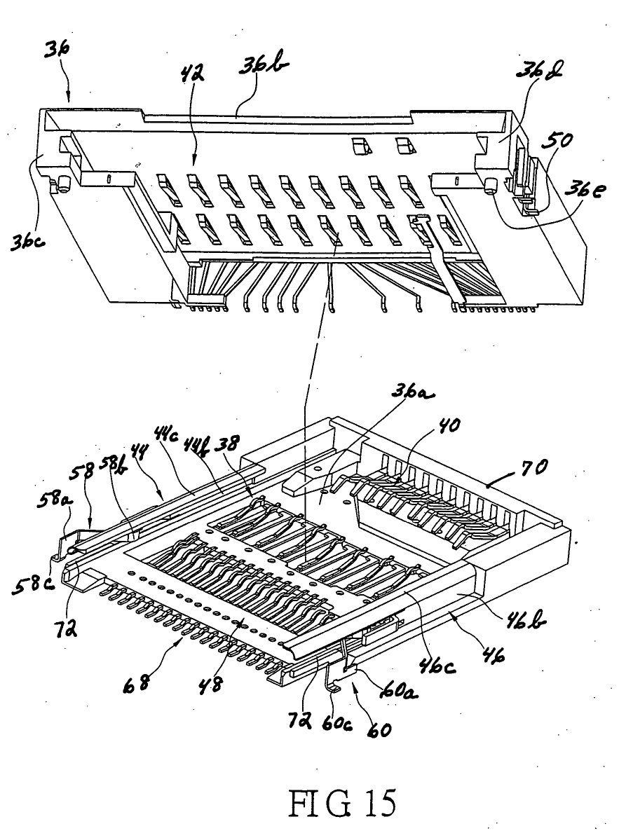

FIGS. 14 and 15 show a second embodiment of the invention wherein a fourth set of conductive terminals, generally designated 68, are mounted on base portion 36a of a bottom section 70 of housing 36. Guide terminals 44 and 46 are the same as in the first embodiment, except that the guide terminals are provided with guide grooves 72 formed in the front of upstanding walls 44b and 46b of the terminals.

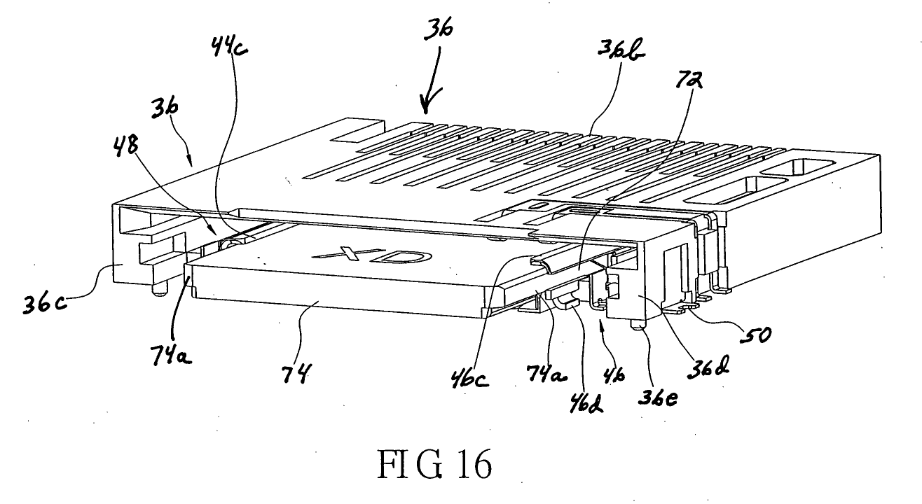

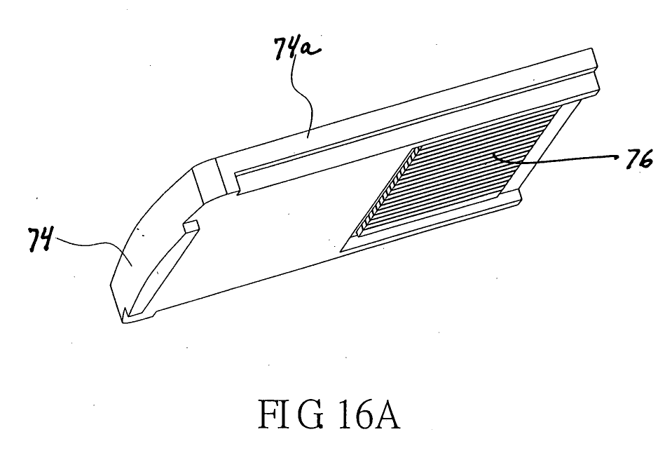

FIGS. 16 and 16A show an XD type memory card 74 for insertion into card-receiving space 48 of the connector. As seen best in FIG. 16A, the XD card includes a guide rail or flange 74a extending longitudinally along each opposite side of the memory card. When the XD card 74 is inserted into card-receiving space 48 as seen in FIG. 16, guide rails 74a of XD card 74 slide within guide grooves 72 of guide terminals 44 and 46. When fully inserted, appropriate contacts 76 (FIG. 16A) engage the fourth set of terminals 68.

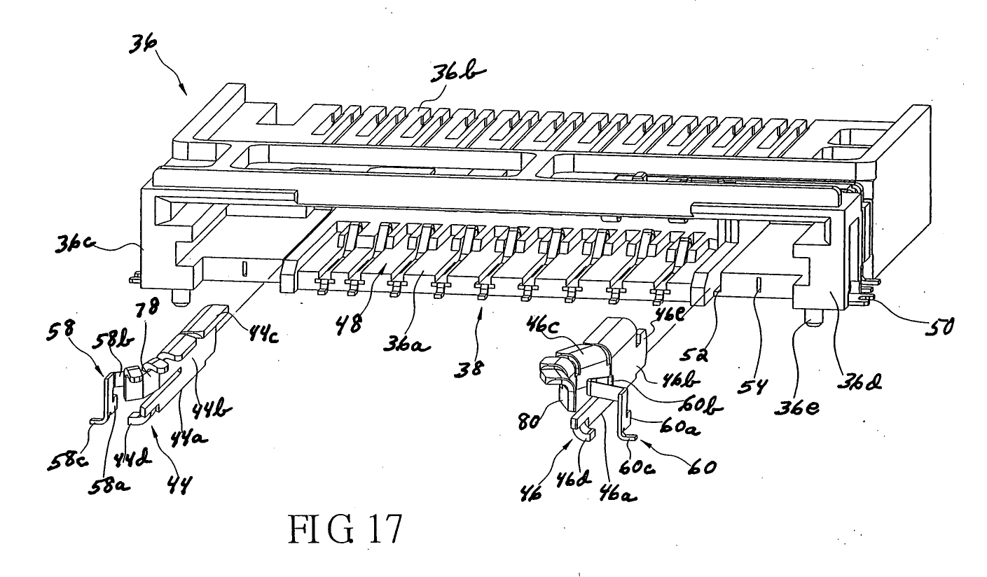

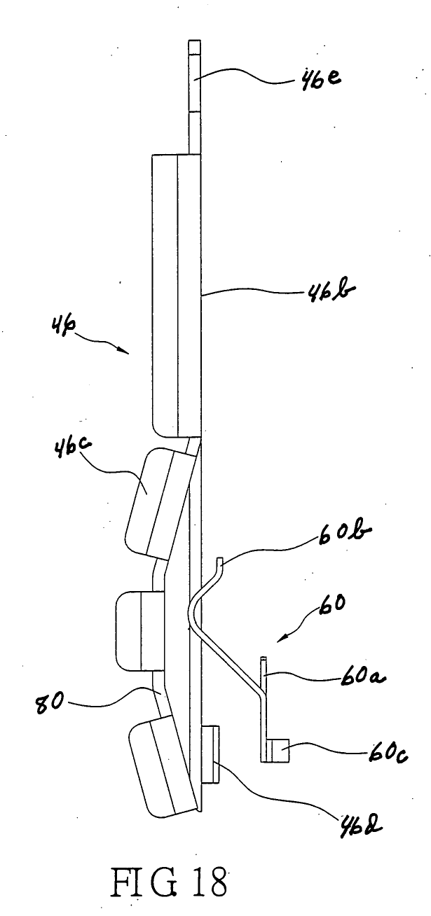

FIGS. 17 and 18 show a third embodiment of the invention wherein upstanding walls 44b and 46b of body portions 44a and 46a, respectively, of guide terminals 44 and 46, respectively, are formed with arc-shaped elastic arms 78 and 80, respectively, which are curved inwardly. Horizontal walls 44c and 46c are segmented into a plurality of sections, as shown. When an SD type card (FIGS. 8 and 8A) is inserted into card-receiving space 48, the side surfaces of the card will engage the insides of the arc-shaped elastic arms 78 and 80, with the top surface of the card engaging the bottom surface(s) of the segmented horizontal walls 44c and 46c. The inserted card will bias elastic arm 78 outwardly into engagement with contact arm 48b of write-protection switch terminal 58 to effect the write-protection function of the connector. The right-hand edge of the card will bias elastic arm 67 of guide terminal 46 outwardly into engagement with contact arm 60b of card detection terminal 60 to effect the card detection function of the connector.

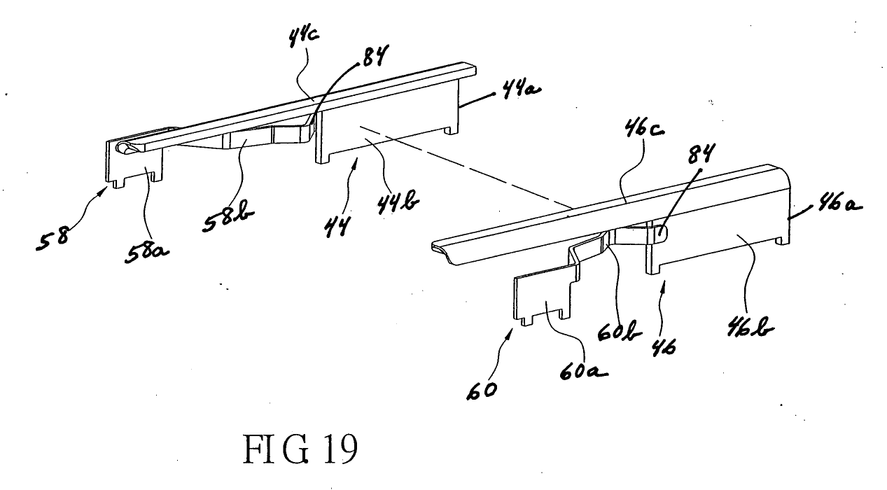

FIG. 19 shows a fourth embodiment of the invention wherein the write-protection switch assembly and the card detection switch assembly both are in a normally closed condition, and the switches are opened by the insertion of a memory card. Specifically, it can be seen that movable contact arms 58b and 60b of the write-protection switch terminal 58 and the card detection switch terminal 60 have tabs 84 at the distal ends thereof. These tabs are maintained in normal engagement with upright walls 44b and 46b of guide terminals 44 and 46, respectively. The remainder of movable contact arms 58b and 60b project inwardly of upright walls 44b and 46b for engagement by an inserted memory card. When the card is inserted into the card-receiving space, the side edges of the card engage movable contact arms 58b and 60b to move tabs 84 outwardly away from upstanding walls 44b and 46b to open the [symbol] switches [symbol] afforded by terminals 44 and 58 as well as terminals 46 and 60.

In summation, it can be understood from the foregoing description that the invention provides a memory card connector which is capable of efficiently guiding and aligning different types of memory cards 62, 64, 66 and 74 by means of two very simple but multi-functional guide terminals 44 and 46. In turn, these guide terminals perform still further functions as comprising fixed switch terminals in the write-protection terminal assembly and the card detection terminal assembly described above.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector, comprising:
an insulating housing which at least in part defines a card-receiving space for receiving one or more different types of memory cards;
a first set of conductive terminals mounted on the housing for engaging appropriate contacts on a first type of memory card inserted into said space;
a second set of conductive terminals mounted on the housing for engaging appropriate contacts on a second type of memory card inserted into said space; and
first and second conductive guide terminals respectively mounted at opposite sides of said card-receiving space and including generally rigid body portions having first guide surfaces for guiding the first type of memory card into the card-receiving space and second guide surfaces independent of the first guide surfaces for guiding the second type of memory card into the card-receiving space.

2. The memory card connector of claim 1 wherein the body portions of said guide terminals include generally upright walls having inside surfaces defining one of said first or second guide surfaces.

3. The memory card connector of claim 1 wherein the body portions of said guide terminals include generally horizontal walls having inside edges defining one of said first or second guide surfaces.

4. The memory card connector of claim 1 wherein the body portions of said guide terminals include generally horizontal walls, the tops of which define one of said first or second guide surfaces.

5. The memory card connector of claim 1, including a third set of conductive terminals mounted on the housing for engaging appropriate contacts on a third type of memory card, and the body portions of said guide terminals have third guide surfaces independent of the first and second guide surfaces for guiding the third type of memory card into the card-receiving space.

6. The memory card connector of claim 1 wherein one of said first and second conductive guide terminals comprises a fixed write-protection switch terminal, and including a movable write-protection switch terminal having a portion engageable by a memory card inserted into the card-receiving space to move the movable switch terminal into engagement with the fixed switch terminal.

7. The memory card connector of claim 1 wherein one of said first and second conductive guide terminals comprises a fixed card detection switch terminal, and including a movable card-detection switch terminal having a portion engageable by a memory card inserted into the card-receiving space to move the movable switch terminal into engagement with the fixed switch terminal.

8. The memory card connector of claim 1 wherein said first and second conductive guide terminals include feet portions fixable to a printed circuit board.

9. A memory card connector, comprising:
an insulating housing which at least in part defines a card-receiving space for receiving one or more different types of memory cards;
a first set of conductive terminals mounted on the housing for engaging appropriate contacts on a first type of memory card inserted into said space;
a second set of conductive terminals mounted on the housing for engaging appropriate contacts on a second type of memory card inserted into said space; and
first and second conductive guide terminals respectively mounted at opposite sides of said card-receiving space, each of said guide terminals being elongated and having inverted L-shaped configurations in cross-section to define an upright wall and a horizontal wall extending inwardly toward the card-receiving space, the inside surfaces of the upright walls defining first guide surfaces for guiding the first type of memory card into the card-receiving space, and the inside edges of the horizontal walls defining second guide surfaces independent of the first guide surfaces for guiding the second type of memory card into the card-receiving space.

10. The memory card connector of claim 9, including a third set of conductive terminals mounted on the housing for engaging appropriate contacts on a third type of memory card, and the guide terminals have third guide surfaces independent of the first and second guide surfaces for guiding the third type of memory card into the card-receiving space.

11. The memory card connector of claim 10 wherein said third guide surfaces are defined by the top surfaces of the horizontal walls of the guide terminals.

12. The memory card connector of claim 9 wherein one of said first and second conductive guide terminals comprises a fixed write-protection switch terminal, and including a movable write-protection switch terminal having a portion engageable by a memory card inserted into the card-receiving space to move the movable switch terminal into engagement with the fixed switch terminal.

13. The memory card connector of claim 9 wherein one of said first and second conductive guide terminals comprises a fixed card detection switch terminal, and including a movable card-detection switch terminal having a portion engageable by a memory card inserted into the card-receiving space to move the movable switch terminal into engagement with the fixed switch terminal.

14. The memory card connector of claim 9 wherein said first and second conductive guide terminals include feet portions fixable to a printed circuit board.

15. A memory card connector, comprising:
an insulating housing which at least in part defines a card-receiving space;
a set of conductive terminals mounted on the housing for engaging appropriate contacts on a memory card inserted into said space;
a fixed switch terminal mounted at one side of the card-receiving space and including a generally rigid body portion for engaging and guiding a memory card into said space; and
a movable switch terminal mounted adjacent the fixed switch terminal and having a portion engageable by a memory card inserted into the card-receiving space to move the movable switch terminal into engagement with the fixed switch terminal.

16. The memory card connector of claim 15 wherein said switch terminals form a write-protection switch, and the switch terminals include feet portions fixable to appropriate circuit traces on a printed circuit board.

17. The memory card connector of claim 15 wherein said switch terminals form a card detection switch, and the switch terminals include feet portions fixable to appropriate circuit traces on a printed circuit board.

18. The memory card connector of claim 15 wherein said fixed and movable switch terminals comprise first switch terminals, and including:
a second fixed switch terminal mounted at an opposite side of the card-receiving space and including a generally rigid body portion for engaging and guiding the memory card into said space, and
a second movable switch terminal mounted adjacent the second fixed switch terminal and having a portion engageable by the memory card inserted into the card-receiving space to move the second movable switch terminal into engagement with the second fixed switch terminal.

19. The memory card connector of claim 18 wherein said first switch terminals form a write-protection switch, and said second switch terminals form a card detection switch.

20. The memory card connector of claim 19 wherein all of said switch terminals include feet portions fixable to appropriate circuit traces on a printed circuit board.
